(19) United States
(12) Patent Application Publication
(10) Pub. No.: US 2013/0177713 A1
(43) Pub. Date: Jul. 11, 2013

(54) COATING METHOD USING MICROBODY ENCAPSULATED COMPONENTS

(71) Applicant: Craig S. Johnson, Clinton, IA (US)

(72) Inventor: Craig S. Johnson, Clinton, IA (US)

(73) Assignee: J. T. CULLEN CO., INC., Fulton, IL (US)

(21) Appl. No.: 13/343,971

(22) Filed: Jan. 5, 2012

(51) Int. Cl. B05D 3/00; B05D 3/02; B05B 1/00; B05D 3/10; B05D 3/12; B05D 3/06; B05D 1/02; B05D 3/14

(52) U.S. Cl. 427/533; 427/331; 427/372.2; 427/398.1; 427/532; 427/337; 427/346; 118/300

(57) ABSTRACT

A method is provided for forming a coating layer on a surface, wherein the coating composition includes at least two reactive components. At least one of the components is encapsulated in a plurality of microspheres, which are then mixed with the second component in a single chamber of a container. The mixture is sprayed from the chamber through a single spray nozzle onto the surface. Then, the microspheres degrade to release the first component and allow the first and second components to react with one another, thereby forming the coating layer on the surface.

### BACKGROUND OF THE INVENTION

Systems and methods for applying dual or multi-component coatings to surfaces are known for use in industrial and commercial applications. However, the equipment is expensive, such that the cost makes such systems and methods prohibitive for many applications, including consumer use.

One example of a multi-component coating consists of a resin and a catalyst which must be mixed and applied to the surface promptly. Premature reaction between the resin and catalyst will clog the equipment and ruin the coating layer. Such premature reaction is precluded or minimized through the use of an expensive plural spray gun which has separate chambers or compartments for each component, such that the components are isolated prior to ejection from the spray nozzle. These plural spraying systems are often used in medical, industrial and commercial applications for two or multi-component coatings.

Microbodies are also known for containing and isolating reactive agents for use in specific applications. These microbodies or microspheres vary in size, composition and types. For example, Yamamoto U.S. Pat. No. 5,948,427 encapsulates reactive agents in a microsphere, which is then heated in a catheter or applicator tip so as to break down the polymeric microsphere and thereby allow the reagents to mix and create a medical or surgical adhesive to be applied by the applicator tip. However, activation of the adhesive components within the applicator requires a heating mechanism within the application to melt, dissolve or degrade the microsphere, and leads to potential clogging of the tip if the reacting components are retained in the tip for too long.

Other examples of various uses of microbodies or microspheres are disclosed in U.S. Pat. No. 7,833,342 (Sambasivan) for use in paint and other applications, and U.S. Published Application 2011/0177141 (Celeste) for various applications.

Accordingly, a primary objective of the present invention is the provision of a method of applying a multi-component coating to a surface or object which overcomes the problems of the prior art.

Another objective of the present invention is the provision of a surface coating method which encapsulates at least one of the reactive coating components in microspheres, and then degrading the microspheres after the components are sprayed onto the surface to allow a reaction between the components so as to form a coating layer on the surface.

A further objective of the present invention is the provision of a method and means of applying a multi-component coating to a surface wherein at least one of the components is encapsulated in a plurality of microspheres such that the encapsulated component is released from the microsphere only after being sprayed on the surface.

Still another objective of the present invention is the method and means of coating a surface with multiple components wherein at least one of the components is contained within a shell of a microbody which is intact and impervious while stored in a spray chamber with the other coating components.

A further objective of the present invention is the provision of a method and means for applying a multi-component sprayed coating, in the form of a paint, foam, lining, plating, overlay, filling, monolith or buildup on a surface.

Another objective of the present invention is the provision of a multi-component coating material wherein at least one of the components is contained within a microbody, and the microbody releases the component through various techniques, such as application or removal of heat, humidity change, pressure change, mechanical manipulation, reaction to chemicals or gases, radiation exposure, application of vibrations, electrical stimulation, ionization, ozonation, and other means.

Yet another objective of the present invention is the provision of an improved coating method and means using microspheres which are suitable for use in multiple applications, including homes, businesses, medical, industrial, commercial, military, and other technical applications.

A further objective of the present invention is the provision of a single chamber sprayer for spraying a mixture having a plurality of microbodies.

Another objective of the present invention is the provision of a multi-chambered spray canister with replaceable multi-chambered or ported spray tips for use in spraying multi-component coatings including microspheres.

A further objective of the present invention is the provision of a multi-component coating composition comprising epoxies, vinyls, esthers, urethanes, geolithical compounds, and/or geopolymer compounds.

Still another objective of the present invention is the provision of an improved method and means for coating a surface which is economical, efficient, and durable, with quick and easy application and clean up.

These and other objectives will become apparent from the following description of the invention.

### SUMMARY OF THE INVENTION

The method of the present invention applies a multi-component coating material to a surface using a spray assembly having a single container for all of the components. To preclude premature interaction of the components within the sprayer container, at least one of the reactive components is encapsulated within a plurality of microbodies or microspheres. The components, including the microbodies, are sprayed simultaneously through a single spray nozzle on to the surface to form a layer. The microbody then degrades or decomposes in response to exposure to a stimulus, such as air, moisture, or other action, so as to release the encapsulated component for reaction with the other component of the coating material.

### BRIEF DESCRIPTION OF THE DRAWINGS

FIG. 1 is a simplified schematic view of a container with a spray nozzle for use in the method according to the present invention.

### DESCRIPTION OF THE INVENTION

The coating material of the present invention comprises two or more reactive reagents or components which, when sprayed upon a surface, react with one another to form a coating layer. At least one of the reactive components is encapsulated in a plurality of microbodies or microspheres, which allow the components to be pre-mixed in a single container while isolating the reactive components from one another. Alternatively, all of the components can be encapsulated in microbodies or microspheres. The microbodies are impervious. A single spray nozzle is used to spray the mixed components onto a surface to be coated. Then the microbodies are degraded or dissolved so that the coating components mix and react with one another to form the coating layer on the surface being sprayed. Such degradation of the microbodies may be accomplished by various means, such as exposure to air, heating, cooling, humidity or moisture, pressure, exposure to chemicals or gases, radiation, vibration, electrical stimulation, ionization, ozonation, and/or mechanical manipulation, such as brushing, rolling, swabbing, or dabbing.

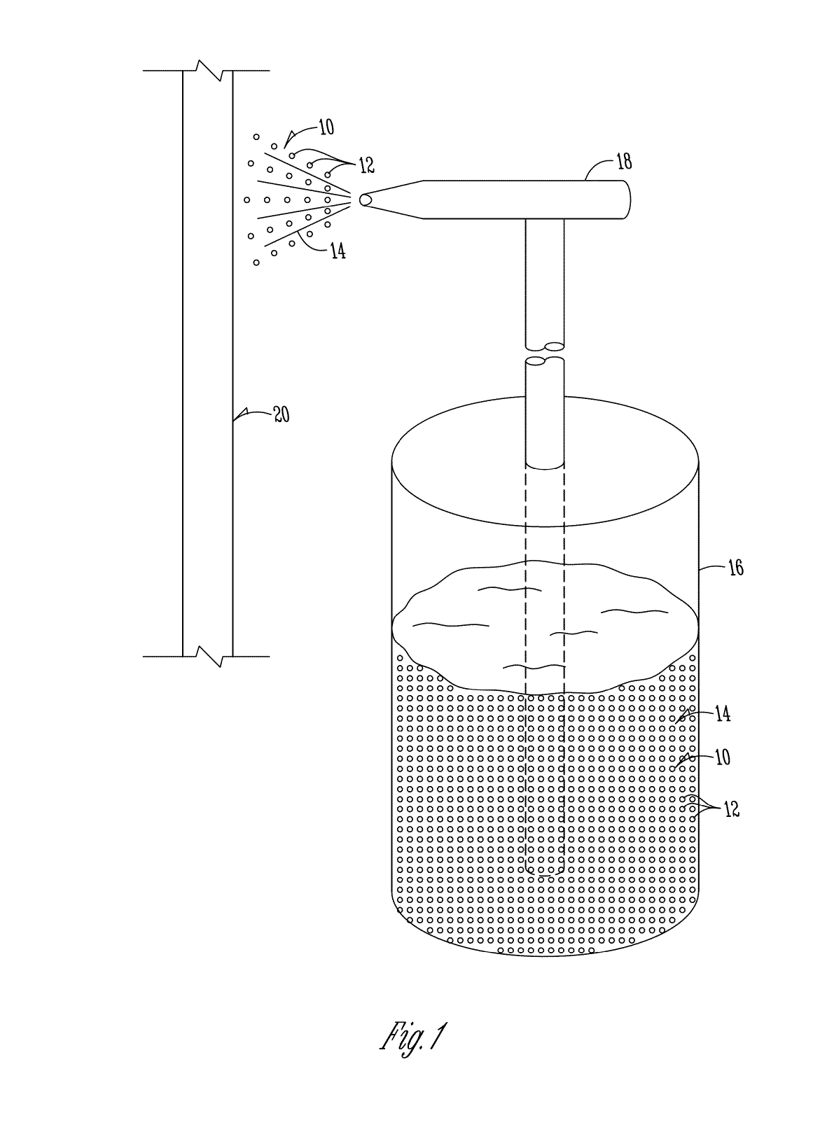

FIG. 1 schematically illustrates one example of the present invention. The coating material 10 includes a plurality of microbodies 12 which encapsulate one of the active ingredients of the coating material 10. Another coating ingredient may be in the form of a liquid 14, or alternatively may be in the form of additional microbodies encapsulating the second ingredient. The ingredients or components 12, 14 are premixed in a container 16, which preferably has a single compartment for housing the components 12, 14. A spray nozzle 18 is operatively connected to the container 16 for spraying the components 12, 14 onto a surface or object 20 to be coated. It is understood that the surface 20 may be any shape or form, planar or non-planar. After the components 12, 14 are sprayed onto the surface 20, the microbodies 12 dissolve or degrade so that the encapsulated ingredient mixes with the second ingredient or component 14 and reacts therewith to form a coating layer on the surface 20.

The container 16 may be pressurized with any suitable inert or semi-inert gas, such as nitrogen, argon, helium, krypton, carbon dioxide, or the like.

The coating material 10 may include two or more components. The reactive components must be isolated from one another in the container 16. The coating material 10 may include an epoxy, vinyl, ester, urethane, and/or geolithical and/or geopolymer-type compounds.

It is understood that the coating method and technique of the present invention forms a layer on the surface or object through the interaction or chemical reaction of the reactive agents or components. The layer may be in the form of paint, a lining, a plating, an overlay, a filling, foam, insulation, and/or a monolith. The coating may also be in the form of a hollow or solid build up, such as those produced in 2-D and 3-D printing in lithographic processes.

The method of the invention may be suitable for consumer use, as well as any and all industrial, commercial, medical, military, and other technical applications. It is also understood that the container 16 may have multiple chambers for separately storing the coating components, with a multi-chambered or ported spray tip, which applies the components in thin, parallel fans which mix and react upon the surface or object being coated.

The microbodies may be sealed with a suitable sealant, such as a film-forming polymer which further creates a barrier against premature mixing of the coating components. Such a sealant will react with moisture in the ambient air so as to degrade and release the encapsulated component for dispersion with the other component or components outside the sprayer or applicator.

One example or embodiment of the present invention is an aluminum phosphate hollow sphere, filled with magnesium hydroxide and sealed with a film-forming polymer. These prepared spheres are mixed with phosphoric acid in the spray canister, which is pressurized with a dry nitrogen gas. The spheres, polymer, magnesium hydroxide, and phosphoric acid are all chemically stable with one another. When the mixture is sprayed from the single chambered canister, the polymer seal will break down due to moisture in the ambient air, thus releasing the magnesium hydroxide into the phosphoric acid so as to produce a geopolymer layer. If the ambient moisture is inadequate, the spraying step can be followed with a light misting or steaming operation to dissolve or decompose the polymer film.

It is understood that as an alternative to the single chamber sprayer described above, the coating compounds can also be isolated in a multi-chamber spray canister with a multi-chambered or ported nozzle for spraying the components. However, these alternative sprayers are much more costly and complex, and do not have the benefits of the preferred single-chamber sprayer.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A method of applying a coating to a surface, the coating having first and second reactive components, the method comprising:
encapsulating the first component in a plurality of first microspheres;
mixing the encapsulated component with the second component in a single chamber;
spraying the mixed components from the chamber onto a surface using a single spray nozzle; and then
degrading the microspheres to release the first component and allow the first and second components to react with one another to form a coating layer on the surface.

2. The method of claim 1 wherein the sprayer uses a multi-chamber nozzle tip.

3. The method of claim 1 further comprising encapsulating the second component in a plurality of second microspheres and degrading the second microspheres after spraying to permit a reaction between the first and second components.

4. The method of claim 1 further comprising pressurizing the container before spraying.

5. The method of claim 1 further comprising sealing the first microspheres.

6. The method of claim 5 wherein the first microspheres are sealed with a polymer film.

7. The method of claim 1 wherein the microspheres are degraded by exposure to air.

8. The method of claim 1 wherein the microspheres are degraded by exposure to moisture.

9. The method of claim 1 wherein the microspheres are degraded by exposure to heat.

10. The method of claim 1 wherein the microspheres are degraded by exposure to cold.

11. The method of claim 1 wherein the microspheres are degraded by exposure to electrical stimulation.

12. The method of claim 1 wherein the microspheres are degraded by mechanical manipulation.

13. The method of claim 1 wherein the microspheres are degraded by exposure to chemicals.

14. The method of claim 1 wherein the microspheres are degraded by exposure to gas.

15. The method of claim 1 wherein the microspheres are degraded by exposure to pressure.

16. The method of claim 1 wherein the microspheres are degraded by exposure to radiation.

17. The method of claim 1 wherein the microspheres are degraded by exposure to vibration.

18. The method of claim 1 wherein the microspheres are degraded by exposure to ionization.

19. The method of claim 1 wherein the microspheres are degraded by exposure to ozonation.

20. In combination, a sprayer with a coating composition including a mixture of first and second reactive components, comprising:
a single chamber for containing the coating composition;
at least one of the reactive components being temporarily encapsulated in a microbody;
a single spray nozzle for simultaneously spraying the mixture of reactive components onto a surface; and then
the microbody releasing the first component for reaction with the second component so as to form a coating layer.
